(19) United States
(12) Patent Application Publication
(10) Pub. No.: US 2026/0148274 A1
(43) Pub. Date: May 28, 2026

(54) SEARCH DEVICE, SEARCHING METHOD, AND RECORDING MEDIUM

(71) Applicant: Rakuten Group, Inc., Tokyo (JP)

(72) Inventor: Kazuhiro SEKINE, Tokyo (JP)

(73) Assignee: Rakuten Group, Inc., Tokyo (JP)

(21) Appl. No.: 19/395,484

(22) Filed: Nov. 20, 2025

(30) Foreign Application Priority Data
Nov. 25, 2024 (JP) 2024-204950

(51) Int. Cl. G06Q 30/0601

(52) U.S. Cl. CPC G06Q 30/0624; G06Q 30/0643

(57) ABSTRACT

Provided are a search device, a searching method, and a recording medium that allow a user to readily search for desired products. The search device provides a three-dimensional image, and identifies, based on a position selected by a user in a target represented by the three-dimensional image, an intended portion intended by the user. The processor then provides pieces of area information indicating the names of areas encompassing the identified intended portion, identifies items associated with a piece of area information selected by the user, and provides an item list through which the user can purchase any of the identified items. The search device can thus allow the user to readily search for desired products.

### CROSS-REFERENCE TO RELATED APPLICATIONS

This application claims the benefit of Japanese Patent Application No. 2024-204950, filed on November 25, 2024, the entire disclosure of which is incorporated by reference herein.

### FIELD OF THE INVENTION

This application relates to a search device, a searching method, and a recording medium.

### BACKGROUND OF THE INVENTION

In recent years, various efforts have been made to enable an easy search for products, services, and other information. For example, Unexamined Japanese Patent Application Publication No. 2020-064471 discloses an information processing device that allows a user to readily find a product that matches a search request.

The user, however, does not necessarily know the name of the desired product. The above-mentioned information processing device still has room for improvement in enabling the user to readily search for the desired product.

An objective of the present disclosure, which has been accomplished as a solution to the above problem, is to provide a search device, a searching method, and a recording medium that allow a user to readily search for desired products.

### SUMMARY OF THE INVENTION

A search device according to a first aspect of the present disclosure includes at least one processor. The processor provides a three-dimensional image. The processor identifies, based on a position selected by a user in a target represented by the three-dimensional image, an intended portion intended by the user. The processor provides pieces of area information indicating the names of areas encompassing the identified intended portion. The processor identifies items associated with a piece of area information selected by the user from among the provided pieces of area information. The processor provides an item list through which the user can purchase any of the identified items.

The present disclosure can provide a search device, a searching method, and a recording medium that allow a user to readily search for desired products.

### BRIEF DESCRIPTION OF DRAWINGS

A more complete understanding of this application can be obtained when the following detailed description is considered in conjunction with the following drawings, in which:

FIG. 1 illustrates the relationship between a search device, information terminals, and a sales server;

FIG. 2 is a block diagram illustrating an example of the search device;

FIG. 3 is an explanatory diagram illustrating an example of item information;

FIG. 4 is a flowchart illustrating an example of a search requesting process and a searching process;

FIG. 5 is an explanatory diagram illustrating an exemplary screen of an information terminal;

FIG. 6 is an explanatory diagram illustrating another exemplary screen of the information terminal;

FIG. 7 is an explanatory diagram illustrating another exemplary screen of the information terminal;

FIG. 8 is an explanatory diagram illustrating another exemplary screen of the information terminal;

FIG. 9 is an explanatory diagram illustrating another exemplary screen of the information terminal;

FIG. 10 is an explanatory diagram illustrating another exemplary screen of the information terminal;

FIG. 11 is an explanatory diagram illustrating another exemplary screen of the information terminal; and

FIG. 12 is an explanatory diagram illustrating another exemplary screen of the information terminal.

### DETAILED DESCRIPTION OF THE INVENTION

### Entire configuration

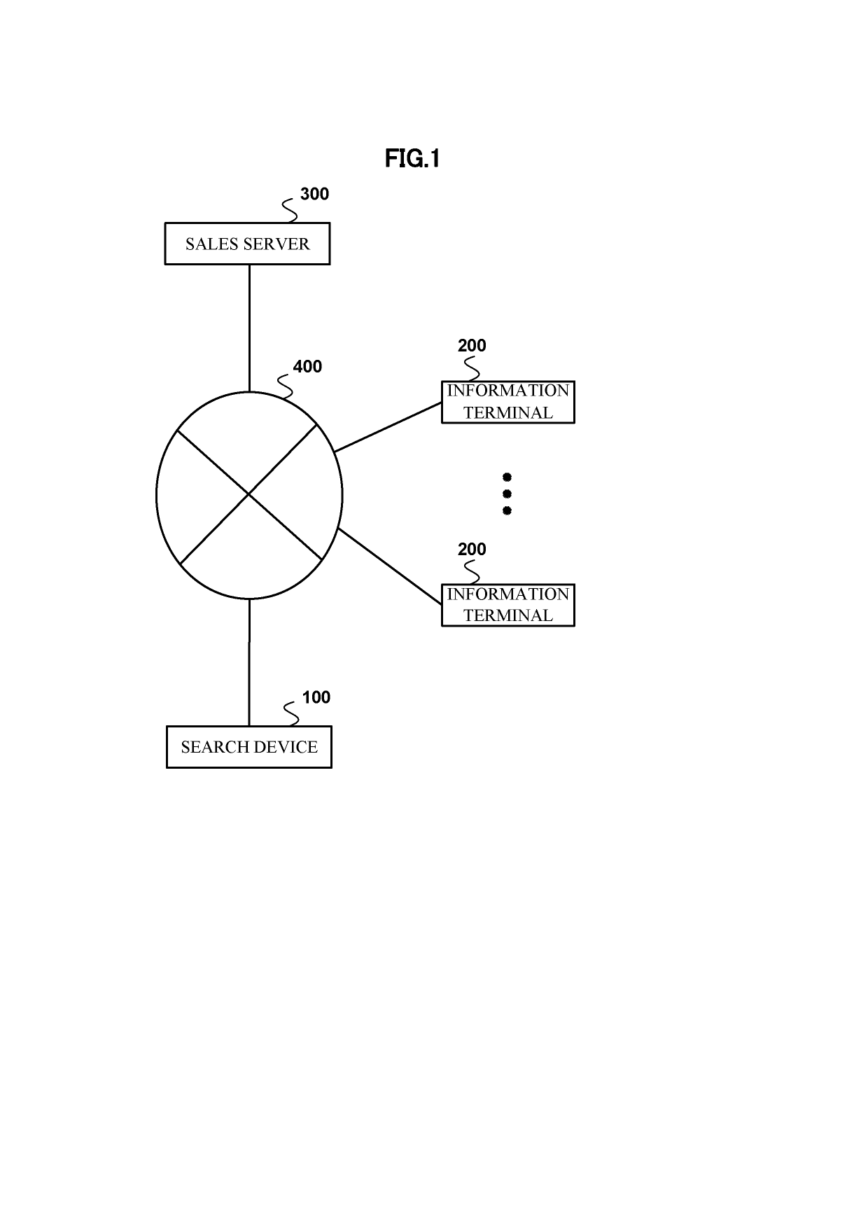

A search device, a searching method, and a recording medium according to an embodiment of the present disclosure are described in detail below with reference to the accompanying drawings. In these drawings, the components identical or corresponding to each other are provided with the same reference symbol. As illustrated in FIG. 1, a search device 100 according to the embodiment of the present disclosure is communicably connected to information terminals 200 and a sales server 300 via a computer communication network 400, such as the Internet. The search device 100 according to the embodiment readily identifies the name of the product in accordance with a user’s designation of the place of use or installation or installation portion of a product to be purchased by the user, and provides a sales website that offers the product. The following description of the embodiment focuses on an exemplary case where the user is going to purchase a car part, in order to facilitate understanding.

The search device 100 is a computer, such as server. The search device 100 identifies the user’s desired product in accordance with a request from the user who uses the information terminal 200, and provides a product page through which the user can purchase the product. Specifically, the search device 100 identifies the car model designated by the user, and provides three-dimensional images associated with the car model. The search device 100 also identifies the applicable items or the parts applicable to the site designated in any of the three-dimensional images, and presents, to the user, an item list containing sales websites through which the user can purchase the respective items. Although the search device 100 in this embodiment is separate from the sales server 300, the search device 100 may be included in the sales server 300 as a functional component.

The information terminal 200 is a so-called computer, such as smartphone, tablet, or personal computer (PC) used by the user. The information terminal 200 provides the search device 100 with car model information indicating the car model to be provided with the desired part, and requests the search device 100 to provide three-dimensional images associated with the car model. The information terminal 200 also provides the search device 100 with information on the areas encompassing the site designated by the user. Furthermore, the information terminal 200 also executes a purchasing step of purchasing the desired product (part) selected from the item list provided from the search device 100, in accordance with a manipulation of the user. The purchasing step involves a sub-step of paying for the desired product by communicating with the sales server 300.

The sales server 300 is a computer, such as a server for selling products. The sales server 300 allows the user to purchase or pay for the product based on a request transmitted in the payment sub-step executed by the information terminal 200.

### Functional configuration of a search device

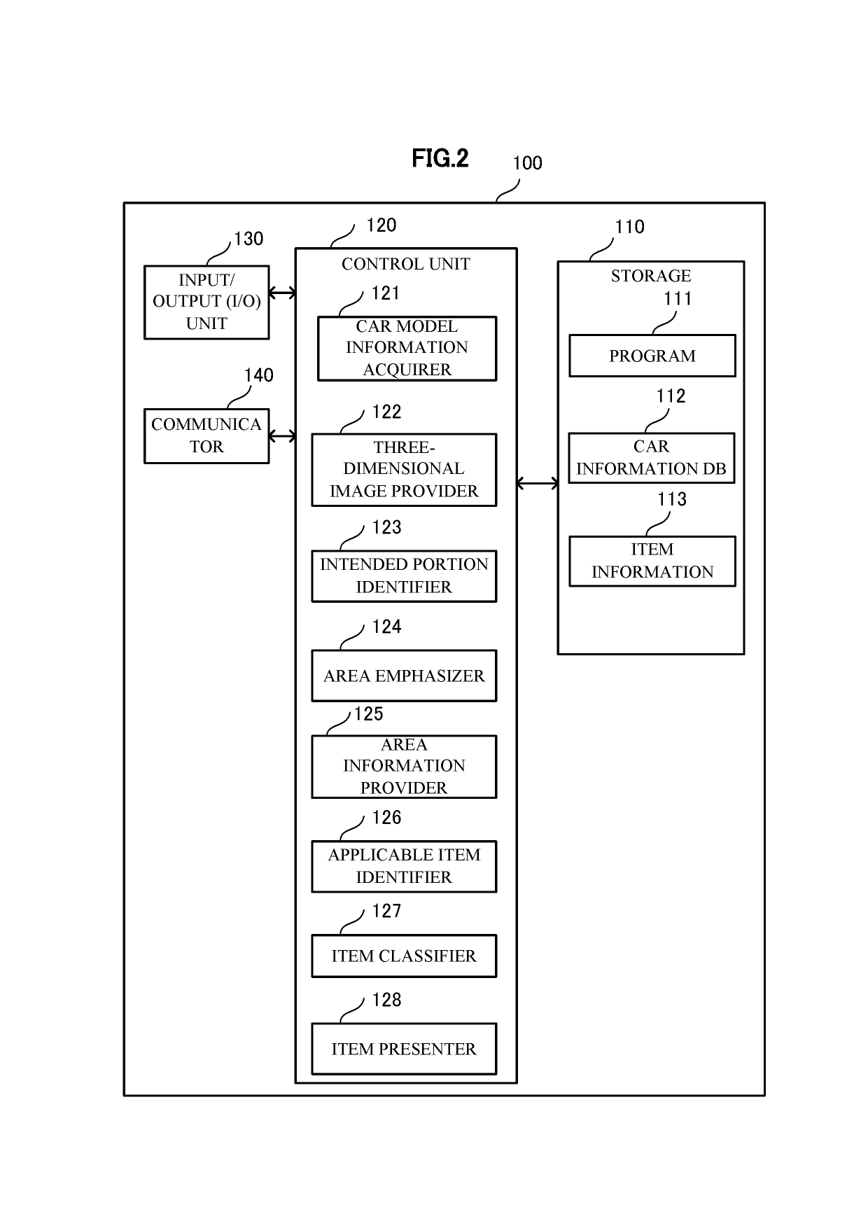

The following describes a configuration of the search device 100, with reference to FIG. 2.

As illustrated in FIG. 2, the search device 100 includes a storage 110, a control unit 120, an input/output (I/O) unit 130, a communicator 140, and a system bus (not illustrated) that connects these components with each other.

The storage 110 includes a read only memory (ROM) and a random access memory (RAM), for example. The ROM stores a program 111 to be executed by the control unit 120, various types of data (not illustrated) that must be prepared in advance of execution of the program 111, a car information database (DB) 112, and item information 113.

The program 111 causes execution of a searching process, which is described below, and is preliminarily stored in the storage 110.

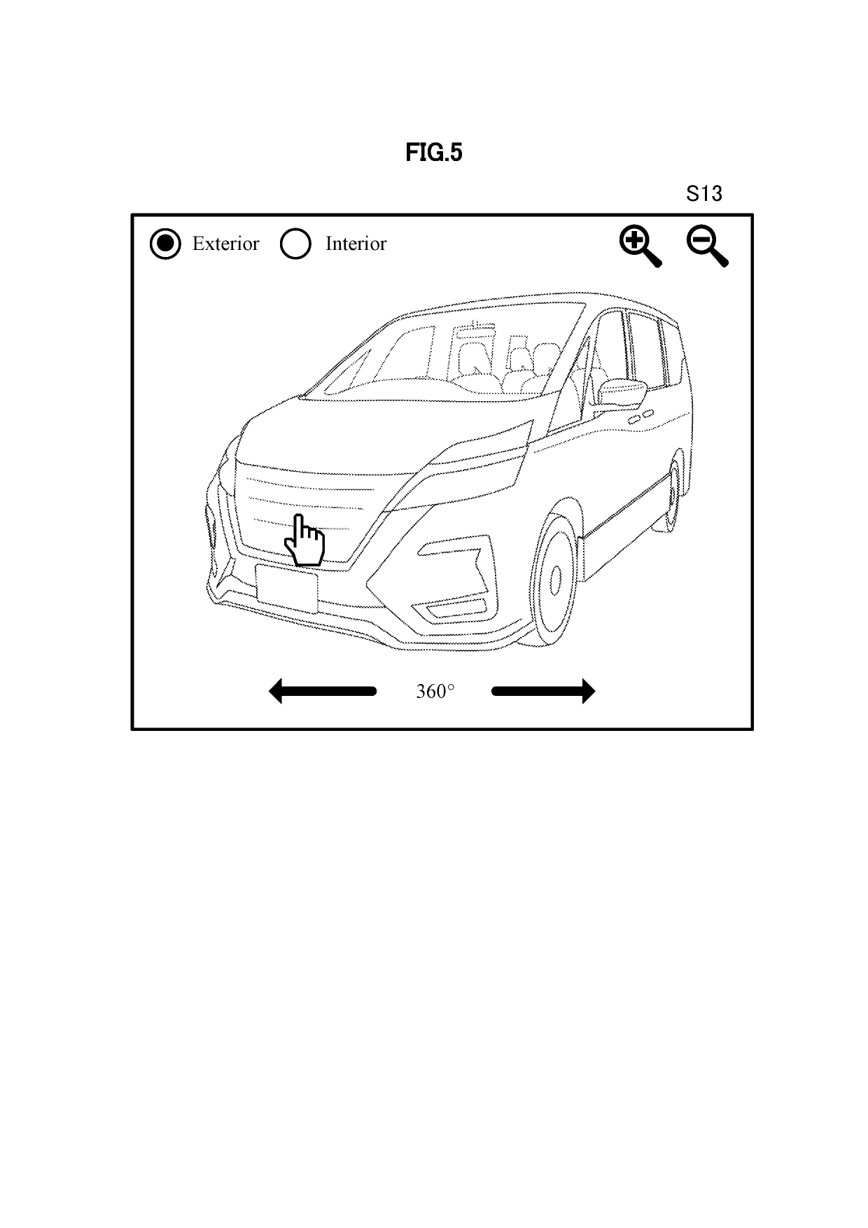

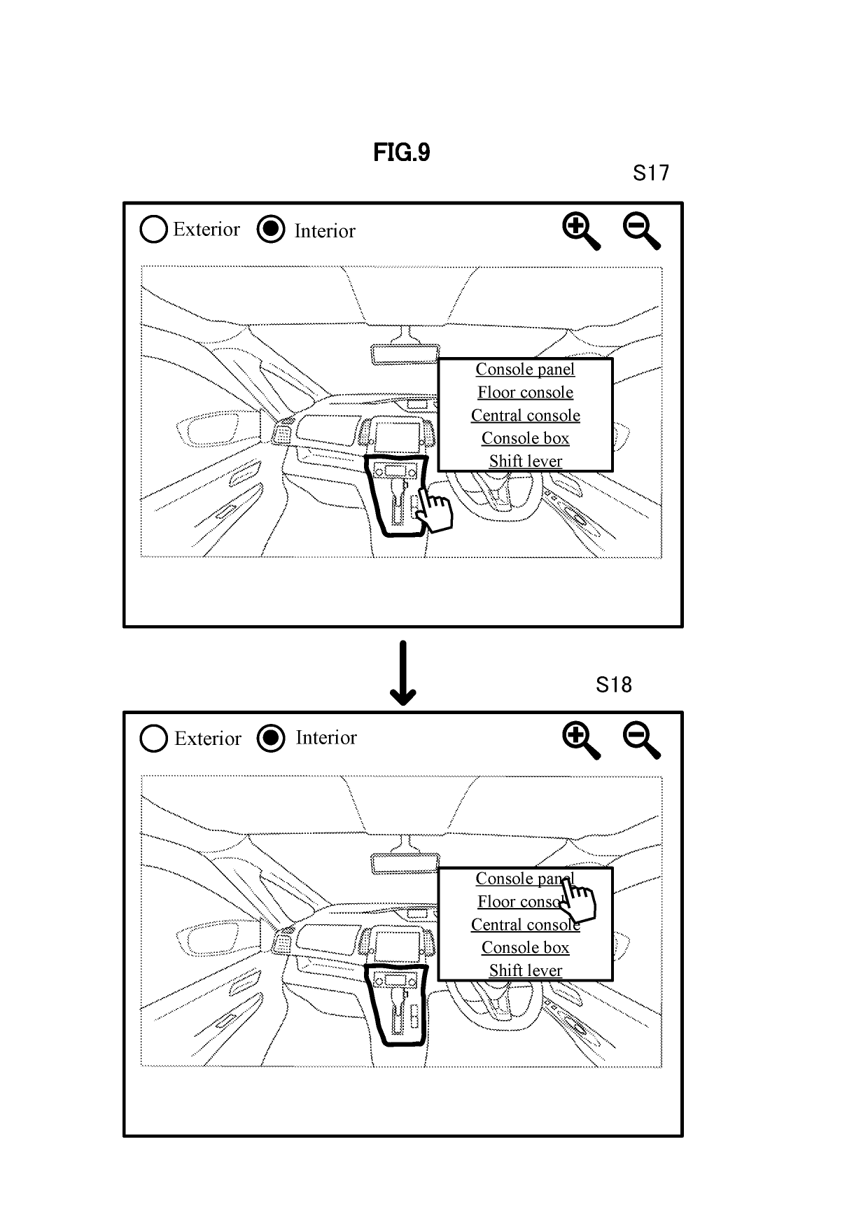

The car information DB 112 stores three-dimensional images (including three-dimensional exterior and interior images) associated with each car model, the names of the individual positions (coordinates) in each of the three-dimensional images, and pieces of area information (installation portion information) on the portions corresponding to the positions. For an exemplary three-dimensional image of the car model of minivan illustrated in FIG. 5, the car information DB 112 stores the designated position pointed by the cursor in the figure, the name “front grille”, and a piece of area information corresponding to the “front grille”, in association with each other. For another exemplary three-dimensional image of the car model of minivan illustrated in FIG. 9, the car information DB 112 stores the designated position pointed by the cursor, the names illustrated in the figure that include the name “console panel”, and a piece of area information corresponding to the “console panel”, in association with each other. That is, the car information DB 112 contains not only the individual positions and names (including alias names) in each of the three-dimensional images associated with each car model, but also the names of installation portions (smaller installation portions) included in the installation portion (larger installation portion) indicated by each of the positions. In other words, as illustrated in FIG. 9, the car information DB 112 contains, as well as the name “console panel” associated with the designated position, the name “shift lever” located within the area encompassing the designated position, and its piece of area information (installation portion information). The pieces of area information contain both a piece of information on the larger installation portion and pieces of information on the smaller installation portions. Alternatively, the car information DB 112 may store three-dimensional images associated with the car itself, the names associated with the individual positions in each image, and their pieces of area information (installation portion information), instead of the three-dimensional images associated with the car model, the names associated with the individual positions in each image, and their pieces of area information. Specifically, the car information DB 112 may store three-dimensional images (including three-dimensional exterior and interior images) associated with the car named “XXX” available from Company A, the names associated with the individual positions in each image associated with the car “XXX”, and their pieces of area information (installation portion information), instead of three-dimensional images (including three-dimensional exterior and interior images) associated with the model “minivan” including cars named “XXX” available from Company A and cars named “YYY” available from Company B, the names in each image associated with the car model, and their pieces of area information. The car model may include multiple sub-models. For example, the model “minivan” includes sub-models “Minivan 1” to “Minivan 5”. The car information DB 112 in this embodiment is preliminarily acquired from the sales server 300 via the computer communication network 400, such as the Internet.

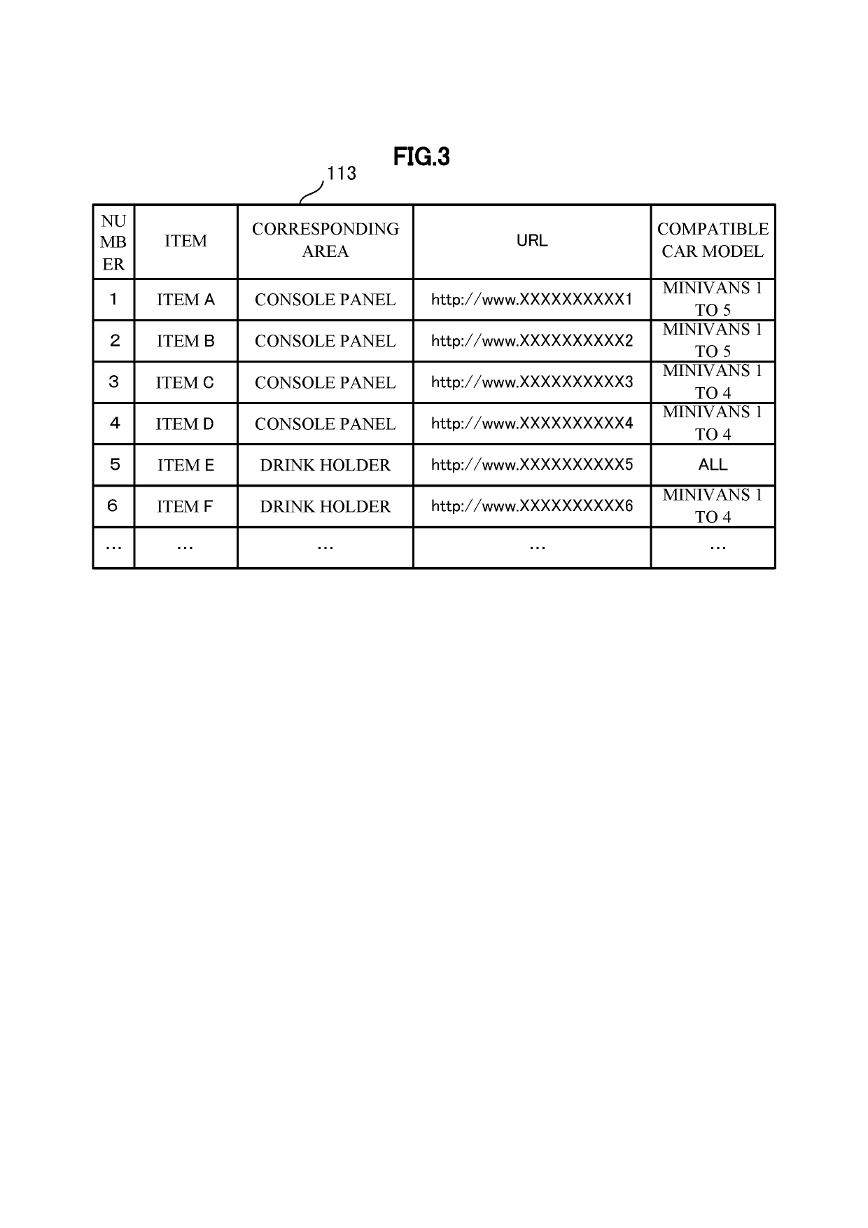

Referring back to FIG. 2, the item information 113 indicates a list of items (parts) that the user can purchase. The item information 113 in this embodiment is preliminarily acquired from the sales server 300 via the computer communication network 400, such as the Internet. Specifically, as illustrated in FIG. 3, the item information 113 in this embodiment contains at least number information indicating numbers, item information indicating the names of items, corresponding area information indicating the positions or the installation portions in each three-dimensional image, uniform resource locator (URL) information indicating the URLs of sales websites provided by the sales server 300, and compatible car model information indicating car models compatible to the items (parts). In the example illustrated in FIG. 3, “Item A” of Number 1 is applicable to the “console panel”, compatible with the car models “Minivans 1 to 5”, and sold at the sales website “http://www.XXXXXXXXXX1”.

The control unit 120 illustrated in FIG. 2 includes a central processing unit (CPU) and an application specific integrated circuit (ASIC), for example. The control unit 120 operates in accordance with the program 111 stored in the storage 110, and executes processes in accordance with the program 111. The control unit 120 includes, as main functional components implemented by the program 111 stored in the storage 110, a car model information acquirer 121, a three-dimensional image provider 122, an intended portion identifier 123, an area emphasizer 124, an area information provider 125, an applicable item identifier 126, an item classifier 127, and an item presenter 128.

The car model information acquirer 121 is a functional component that acquires, from each of the information terminals 200, car model information on the car model compatible with the user’s desired part. Specifically, the car model information acquirer 121 can acquire, from the information terminal 200, car model information on the car model selected by the user through a selection manipulation in the application activated in the information terminal 200, for example. In this embodiment, the car model information is transmitted from the information terminal 200 to the search device 100 when the user of the information terminal 200 presses a car model determining button.

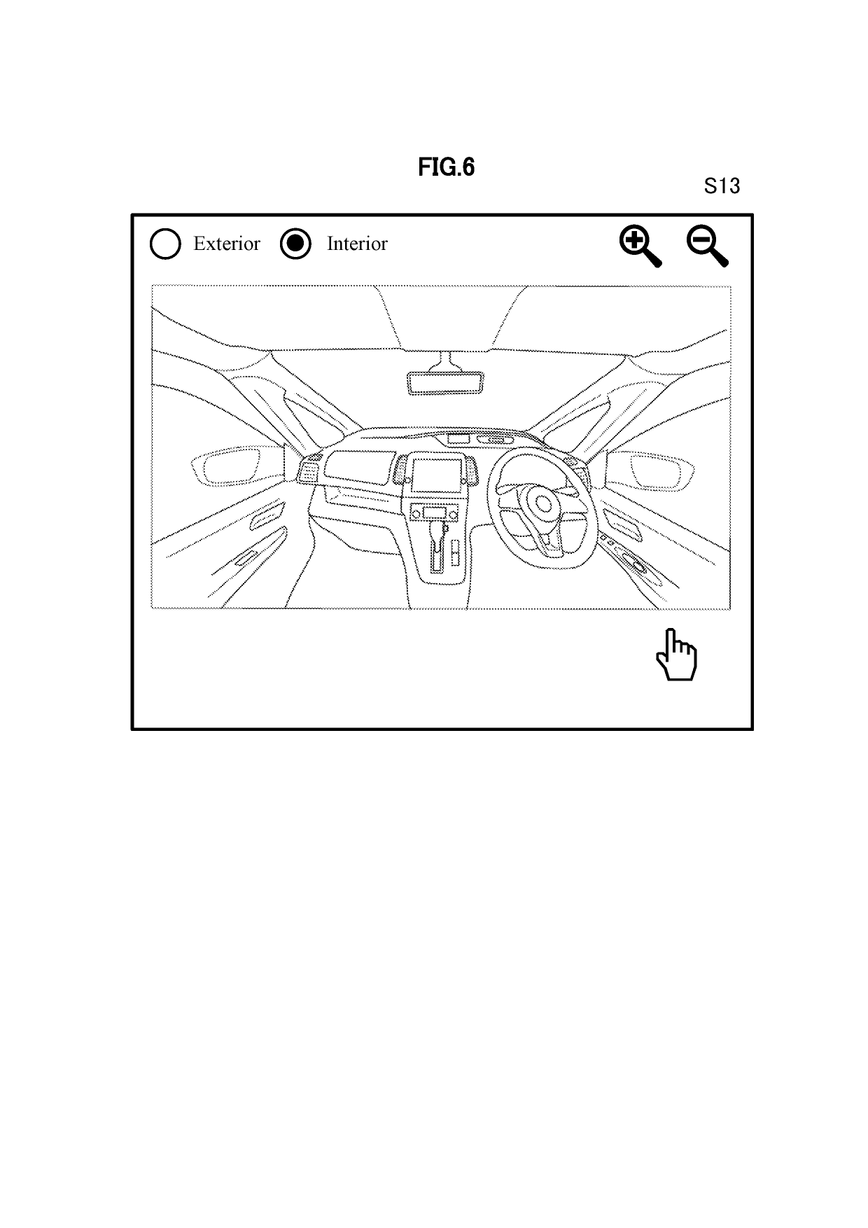

The three-dimensional image provider 122 is a functional component that provides the information terminal 200 with three-dimensional images associated with the car model indicated by the car model information. Specifically, the three-dimensional image provider 122 acquires three-dimensional images of the car model indicated by the car model information acquired by the car model information acquirer 121, from the car information DB 112 stored in the storage 110, and then provides the information terminal 200 with the acquired three-dimensional images. The three-dimensional images provided to the information terminal 200 by the three-dimensional image provider 122 include both three-dimensional exterior images and three-dimensional interior images (refer to FIGS. 5 and 6). The user can scroll up, down, right, and left in the displayed three-dimensional image provided by the three-dimensional image provider 122.

The intended portion identifier 123 illustrated in FIG. 2 is a functional component that identifies the intended portion to be provided with the user’s desired part. Specifically, the intended portion identifier 123 acquires, as selected site information, the site designated by the user in any of the three-dimensional images provided to the information terminal 200 by the three-dimensional image provider 122, and identifies the portion encompassing the site indicated by the selected site information, to be the intended portion where the user is intended to install the part. The intended portion identifier 123 may identify the intended portion at multiple timings. Examples of the timings include the timing of positioning the cursor in the three-dimensional image, and the timing of pressing an intended portion determining button. In this embodiment, the intended portion identifier 123 acquires the intended portion at the timing of positioning the cursor in the three-dimensional image. That is, when the user positions the cursor in the three-dimensional image, information on the corresponding site is transmitted as the selected site information from the information terminal 200 to the search device 100. In other words, the selected site information is transmitted after every user’s manipulation to move the cursor, and the intended portion identifier 123 identifies the portion indicated by the selected site information to be the intended portion after every transmission. More specifically, the intended portion identifier 123 identifies the intended portion (installation portion) corresponding to the site (coordinates) indicated by the selected site information, on the basis of the car information DB 112 stored in the storage 110.

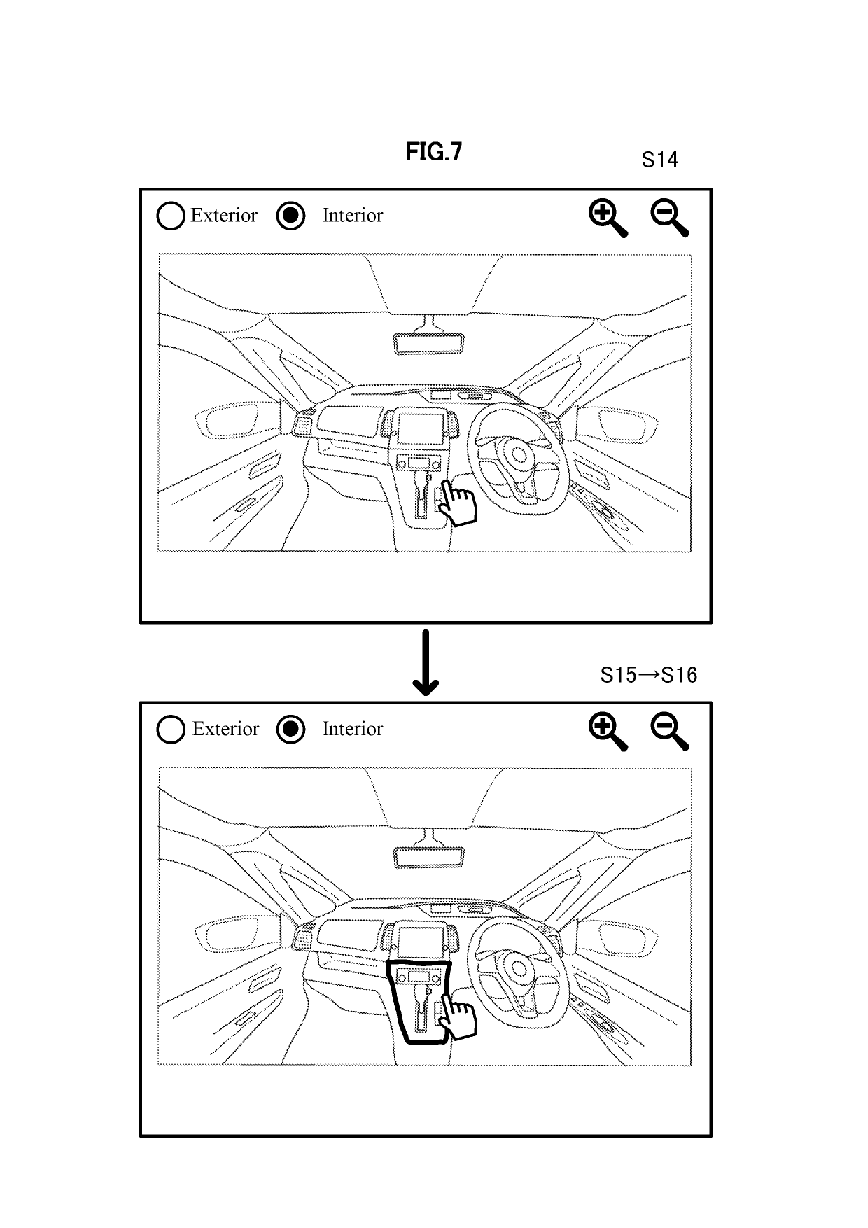

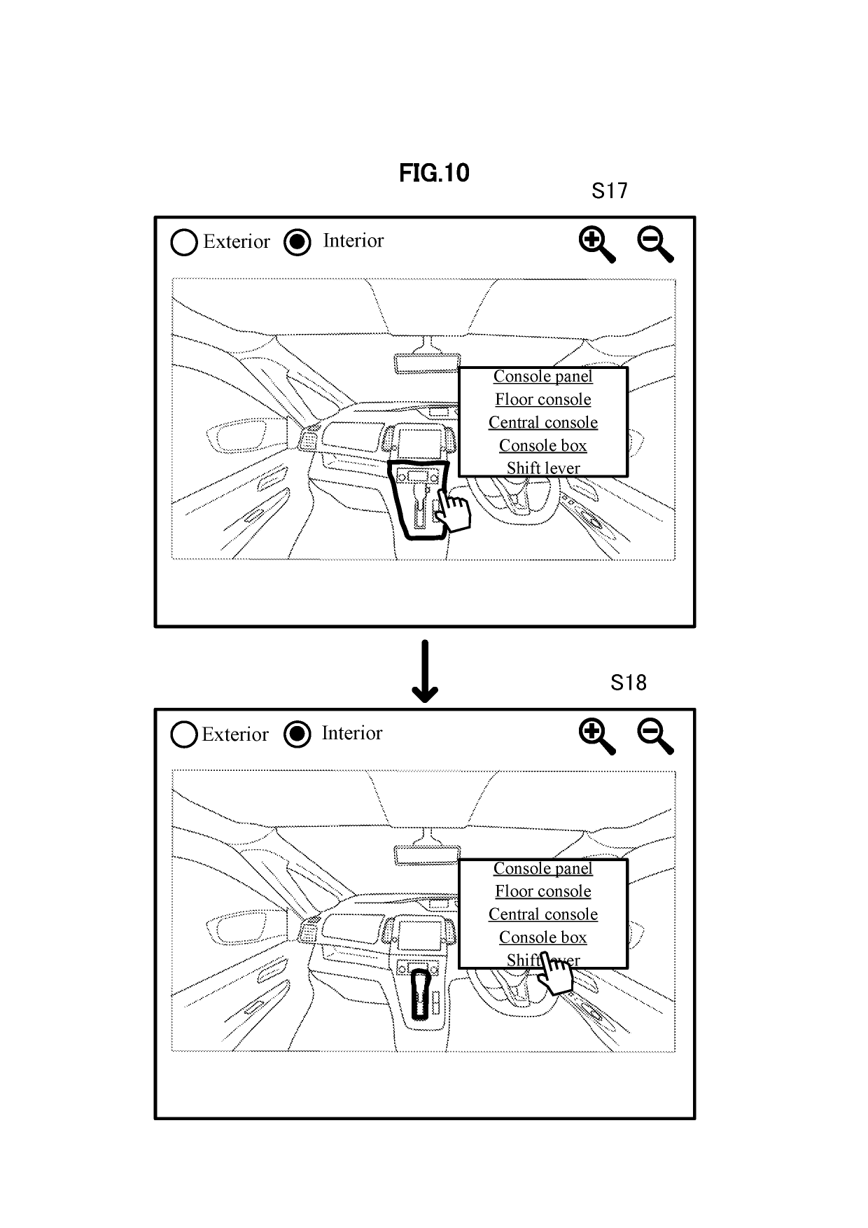

The area emphasizer 124 is a functional component that emphasizes the area of the intended portion identified by the intended portion identifier 123. Specifically, the area emphasizer 124 determines that the area of the intended portion (installation portion) identified by the intended portion identifier 123 encompasses the user’s intended installation portion, and emphasizes the area. For example, in the example illustrated in FIG. 7, the intended portion identifier 123 identifies the portion encompassing the designated position pointed by the cursor in the figure to be the intended portion, and the area emphasizer 124 emphasizes the area corresponding to this position. The selected site information in this embodiment is transmitted after every user’s manipulation to move the cursor as described above, and the intended portion identifier 123 thus identifies the intended portion corresponding to the site indicated by the selected site information after every transmission. The area emphasizer 124 thus emphasizes the area encompassing the intended portion after every identification of the intended portion by the intended portion identifier 123. The area emphasizer 124 also emphasizes the area indicated by the selection information, transmitted in response to the selection of a smaller installation portion contained in the pieces of area information provided by the area information provider 125, which is described below. For example, when the information terminal 200 is provided with the pieces of area information containing the piece indicating the name “console panel” as illustrated in the upper part of FIG. 10 by the area information provider 125, which is described below, and receives selection of the smaller installation portion “shift lever” contained in the pieces of area information, then the information terminal 200 transmits the selection information indicating the selection of the “shift lever” to the search device 100. The area emphasizer 124 accordingly emphasizes the area of “shift lever”, as illustrated in the lower part of FIG. 10. That is, the screen for emphasizing “console panel” transitions to the screen for emphasizing “shift lever”. In this case, the intended portion identifier 123 identifies the portion indicated by the selection information to be the intended portion to be emphasized, on the basis of the car information DB 112.

The area information provider 125 is a functional component that provides the information terminal 200 with the pieces of area information indicating the names of the installation portions encompassed in the area emphasized by the area emphasizer 124. Specifically, the area information provider 125 identifies the names of the installation portions encompassed in the area emphasized by the area emphasizer 124 on the basis of the car information DB 112 stored in the storage 110, and provides the information terminal 200 with the identified names of the installation portions as the area information. In an exemplary case where the area emphasizer 124 emphases the area as illustrated in the lower part of FIG. 7, the area information provider 125 identifies the names of the installation portions encompassed in the emphasized area on the basis of the car information DB 112, and provides the information terminal 200 with the identified names of the installation portions as the area information, as illustrated in the upper part of FIG. 9. Although the area information contains the names of multiple installation portions in FIG. 9, this configuration is a mere example. The area information may also contain the name of a single installation portion.

The applicable item identifier 126 is a functional component that identifies the items applicable to the installation portion selected by the user, from among the names of the installation portions contained in the area information provided by the area information provider 125. Specifically, the applicable item identifier 126 acquires, from the information terminal 200, the installation portion selected by the user as the selection information, from among the names of installation portions contained in the area information provided by the area information provider 125. The applicable item identifier 126 then determines the portion indicated by the selection information to be the installation portion of the user’s desired part, and identifies the items applicable to this installation portion on the basis of the item information 113 stored in the storage 110. In an exemplary case where the user’s car is of the model “Minivan 1” and the selection information indicates the installation portion “console panel”, the applicable item identifier 126 identifies, as the applicable items, “Item A” to “Item D” of Numbers 1 to 4 in the item information 113 illustrated in FIG. 3.

The item classifier 127 is a functional component that classifies the items identified by the applicable item identifier 126 into groups. Specifically, the item classifier 127 classifies the items identified by the applicable item identifier 126 into groups of similar items. For example, the applicable item identifier 126 classifies the items identified by the applicable item identifier 126 into groups in accordance with the degrees of similarity between product images of the items, such that each group contains highly similar items. The items may be classified by any procedure, such as principal component analysis or clustering, for example.

The item presenter 128 is a functional component that presents, to the user, an item list of representative items belonging to the respective groups of the items classified by the item classifier 127. Specifically, the item presenter 128 extracts, as the representative item, the largest selling item from among the items belonging to each of the groups formed by the item classifier 127, transmits the list of the extracted items to the information terminal 200, and thus presents the item list to the user. The largest selling item is identified on the basis of information, such as the number of sales, for determining the largest selling item acquired from the sales server 300, for example.

The I/O unit 130 illustrated in FIG. 2 includes a keyboard, a mouse, a camera, a microphone, a liquid crystal display, and an organic electroluminescence (EL) display, for example. The I/O unit 130 inputs and outputs a variety of data.

The communicator 140 enables the search device 100 to communicate with other information terminals, such as the information terminals 200 and the sales server 300, via the computer communication network 400. These components constitute the search device 100.

### Operations

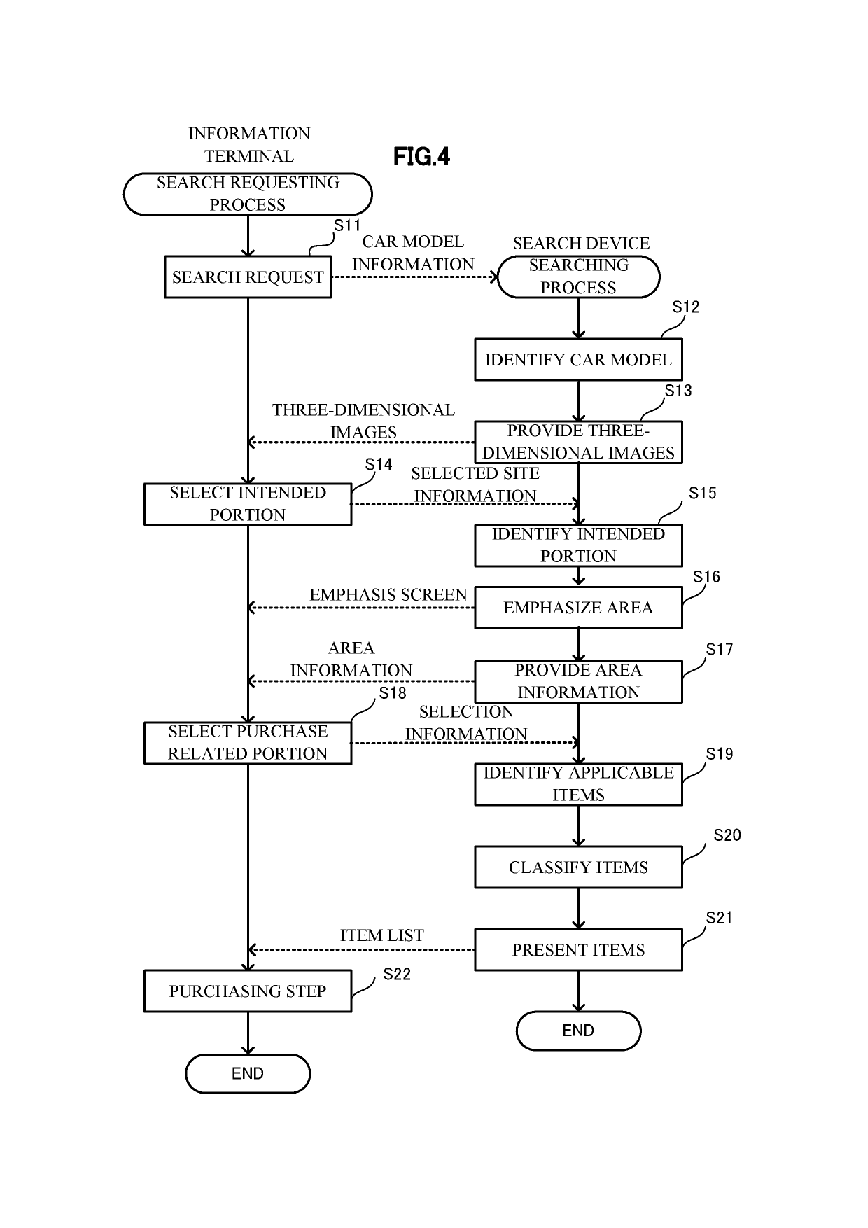

The following describes operations of the search device 100 and each of the information terminals 200. FIG. 4 is a flowchart illustrating an example of a search requesting process executed by the information terminal 200 and a searching process executed by the search device 100. The search requesting process and the searching process in this embodiment enable the identification of the parts applicable to the installation portion intended by the user to receive the part, and the presentation of the item list containing sales websites through which the user can purchase the parts. First, the search requesting process illustrated in FIG. 4 is started when the user who uses the information terminal 200 performs a manipulation in the application. The following description focuses on an example in which the user intends to install a part in the car of the model “Minivan 1”.

At the start of the search requesting process, the information terminal 200 provides a search request in response to user’s manipulations in the application (Step S11). Specifically, the information terminal 200 in Step S11 transmits a search request with the car model information to the search device 100, in response to user’s manipulations of selecting a car model and pressing a search request button.

The search device 100, when receiving the car model information, starts the searching process. At the start of the searching process, the control unit 120 identifies the car model, using the function of the car model information acquirer 121 (Step S12). Specifically, the car model information acquirer 121 in Step S12 determines the car model indicated by the received car model information, to be the car model in which the user intends to install a part.

After Step S12, the control unit 120 provides three-dimensional images, using the function of the three-dimensional image provider 122 (Step S13). Specifically, the three-dimensional image provider 122 in Step S13 acquires the three-dimensional images associated with the car model identified in Step S12, from the car information DB 112 stored in the storage 110, and provides the acquired images to the information terminal 200 that transmitted the car model information. These three-dimensional images provided to the information terminal 200 by the three-dimensional image provider 122 include both three-dimensional exterior images and three-dimensional interior images. The information terminal 200 thus displays a three-dimensional exterior or interior image of the car model (Minivan 1) in which the user intends to install a part, as illustrated in FIGS. 5 and 6.

Referring back to FIG. 4, the information terminal 200 is manipulated by the user to select the intended portion in which the user intends to install the part, in the displayed three-dimensional exterior or interior image (Step S14). Specifically, as illustrated in the upper part of FIG. 7, the intended portion is selected in response to a user’s manipulation of positioning the cursor at the position to be provided with the part. Step S14 also involves, after the selection of the intended portion, transmission of the selected site information indicating the position of the selected site in the three-dimensional image, from the information terminal 200 to the search device 100. FIG. 7 illustrates an example in which the information terminal 200 displays a three-dimensional interior image of the model “Minivan 1” intended by the user. In the example illustrated in the upper part of FIG. 7, the user selects the console panel portion. In this example, the information terminal 200 transmits the selected site information, indicating the selection of the console panel portion in the three-dimensional interior image, to the search device 100. The selected site information may indicate the coordinates of the selected site in the three-dimensional image. As described above, when the user positions the cursor in the three-dimensional image, the information terminal 200 transmits the selected site information (coordinates in the three-dimensional image) on the site pointed by the cursor, to the search device 100.

Referring back to FIG. 4, the control unit 120 of the search device 100, when receiving the selected site information, acquires the intended portion indicating the installation portion to be provided with the user’s desired part, on the basis of the site indicated by the selected site information, using the function of the intended portion identifier 123 (Step S15). Specifically, the intended portion identifier 123 in Step S15 acquires the intended portion indicated by the acquired selected site information, from the car information DB 112 stored in the storage 110. In an exemplary case where the selected site information indicating the selection of the console panel portion in the three-dimensional interior image is transmitted to the search device 100 in Step S14, as illustrated in the upper part of FIG. 7, the intended portion identifier 123 in Step S15 identifies the area of the console panel encompassing the intended portion (installation portion) corresponding to the site (coordinates) indicated by the selected site information, on the basis of the area information contained in the car information DB 112 stored in the storage 110. As described above, the selected site information is transmitted after every user’s manipulation to move the cursor in this embodiment. Step S15, in which the intended portion identifier 123 identifies the portion indicated by the selected site information to be the intended portion, is thus executed after every transmission of the selected site information.

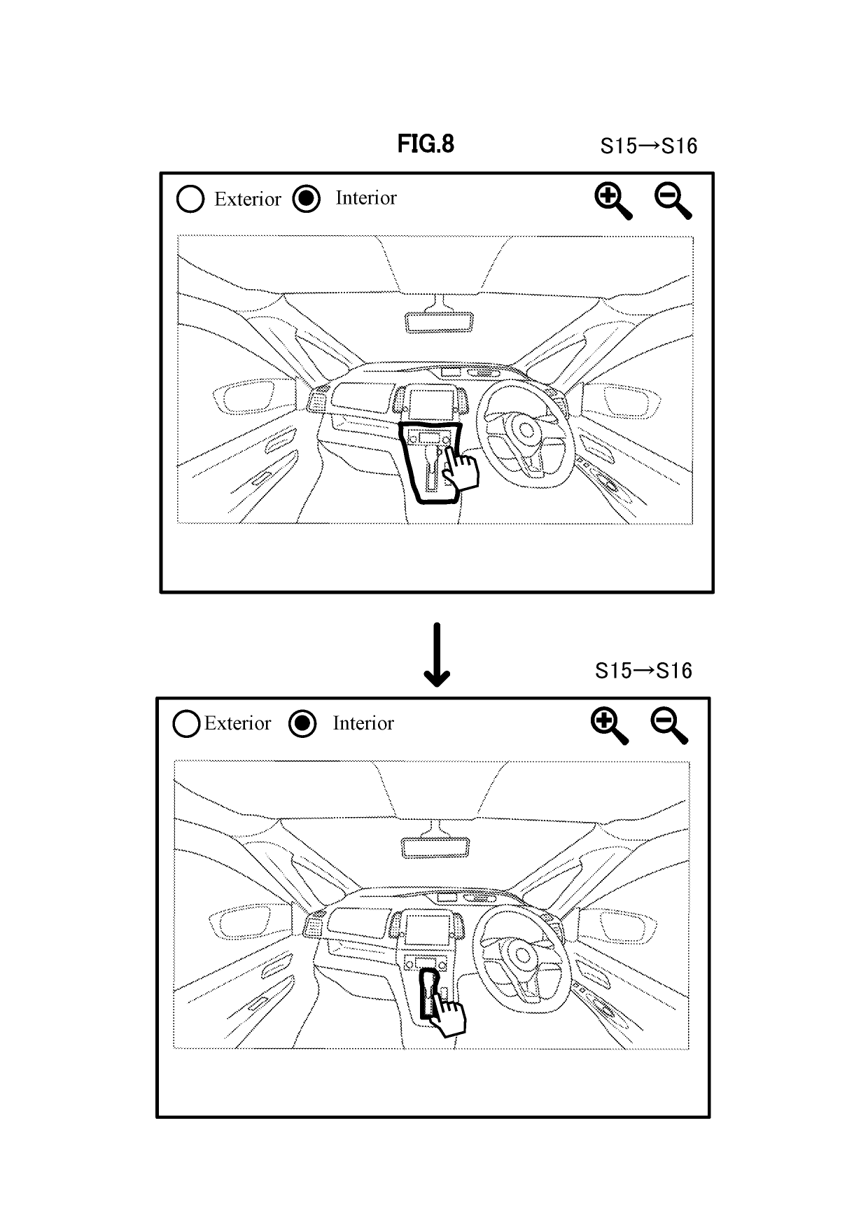

After Step S15 illustrated in FIG. 4, the control unit 120 emphasizes the area encompassing the intended portion identified in Step S15, using the function of the area emphasizer 124 (Step S16). Specifically, the area emphasizer 124 in Step S16 determines the area encompassing the intended portion identified in Step S15 to correspond to the user’s intended installation portion, and emphasizes the area. In an exemplary case where the selected site information indicating the selection of the console panel portion in the three-dimensional interior image is transmitted to the search device 100 in Step S14, as illustrated in the upper part of FIG. 7, the intended portion identifier 123 in Step S15 identifies the area of the console panel encompassing the intended portion (installation portion) corresponding to the site (coordinates) indicated by the selected site information, on the basis of the area information contained in the car information DB 112 stored in the storage 110. The area emphasizer 124 in Step S16 then emphasizes the area of the console panel, as illustrated in the lower part of FIG. 7. As described above, the selected site information is transmitted after every user’s manipulation to move the cursor in this embodiment. Thus, if another selected site information indicating the selection of the shift lever portion is received after the temporary emphasis of the area of the console panel by the area emphasizer 124 in Step S16 as illustrated in the upper part of FIG. 8, the area emphasizer 124 re-executes Step S16, and emphasizes the area of the shift lever as illustrated in the lower part of FIG. 8.

After Step S16 illustrated in FIG. 4, the control unit 120 provides the information terminal 200 with the area information indicating the names of the installation portions encompassed in the area emphasized in Step S16, using the function of the area information provider 125 (Step S17). Specifically, the area information provider 125 in Step S17 identifies the names of the installation portions encompassed in the area emphasized in Step S16 on the basis of the car information DB 112 stored in the storage 110, and then provides the information terminal 200 with the area information indicating the identified names of the installation portions. In an exemplary case where the area is emphasized in Step S16 as illustrated in the lower part of FIG. 7, the area information provider 125 in Step S17 identifies the names of the installation portions encompassed in the emphasized area on the basis of the car information DB 112, and then provides the information terminal 200 with the area information indicating the identified names of the installation portions as illustrated in the upper part of FIG. 9.

Referring back to FIG. 4, the information terminal 200, when receiving the area information, displays the screen illustrated in the upper part of FIG. 9. The information terminal 200 then prompts the user to select the name of the installation portion of the user’s desired part as a purchase related portion (Step S18). Specifically, the user of the information terminal 200 selects the appropriate name from among the names of the installation portions appearing on the screen of the information terminal 200 as the area information, as illustrated in the lower part of FIG. 9. The information terminal 200 then transmits the selection information indicating the selected name to the search device 100 in Step S18. In the illustrated example, the name “console panel” is selected as a purchase related portion, followed by transmission of the selection information indicating the selection of “console panel” to the search device 100. In contrast, in another exemplary case where the information terminal 200 displays the area information illustrated in the upper part of FIG. 10 in Step S17, the cursor is positioned in the area of the shift lever smaller than that of the console panel as illustrated in the lower part of FIG. 10, which is also followed by transmission of the selection information from the information terminal 200 to the search device 100. In this example, the search device 100 re-executes Steps S15 and S16 illustrated in FIG. 4, and thus emphasizes the area of the shift lever indicated by the selection information as illustrated in the lower part of FIG. 10.

Referring back to FIG. 4, the control unit 120 of the search device 100, when receiving the selection information, identifies the items applicable to the installation portion indicated by the selection information, using the function of the applicable item identifier 126 (Step S19). Specifically, the applicable item identifier 126 in Step S19 determines the portion indicated by the selection information transmitted in Step S18 to be the installation portion of the user’s desired part, and identifies the items (parts) applicable to the installation portion, on the basis of the item information 113 stored in the storage 110. In an exemplary case where the user’s car is of the model “Minivan 1” and the selection information indicates the installation portion “console panel” as illustrated in the lower part of FIG. 9, the applicable item identifier 126 in Step S19 identifies, as the applicable items, “Item A” to “Item D” of Numbers 1 to 4 in the item information 113 illustrated in FIG. 3.

After Step S19 illustrated in FIG. 4, the control unit 120 classifies the items identified in Step S19 into groups, using the function of the item classifier 127 (Step S20). Specifically, the item classifier 127 in Step S20 classifies the items identified in Step S19 into groups in accordance with the degrees of similarity between product images of the items, such that each group is made of highly similar items. For the exemplary items identified to be “Item A” to “Item D” in Step S19, the item classifier 127 classifies the “Item A” and “Item B” highly similar to each other into the identical group, and thus classifies the items into three groups: the group including “Item A” and “Item B”, the group including “Item C”, and the group including “Item D”. This example assumes that “Item C” and “Item D” exhibit low degrees of similarity to each other and also exhibit low degrees of similarity with “Item A”.

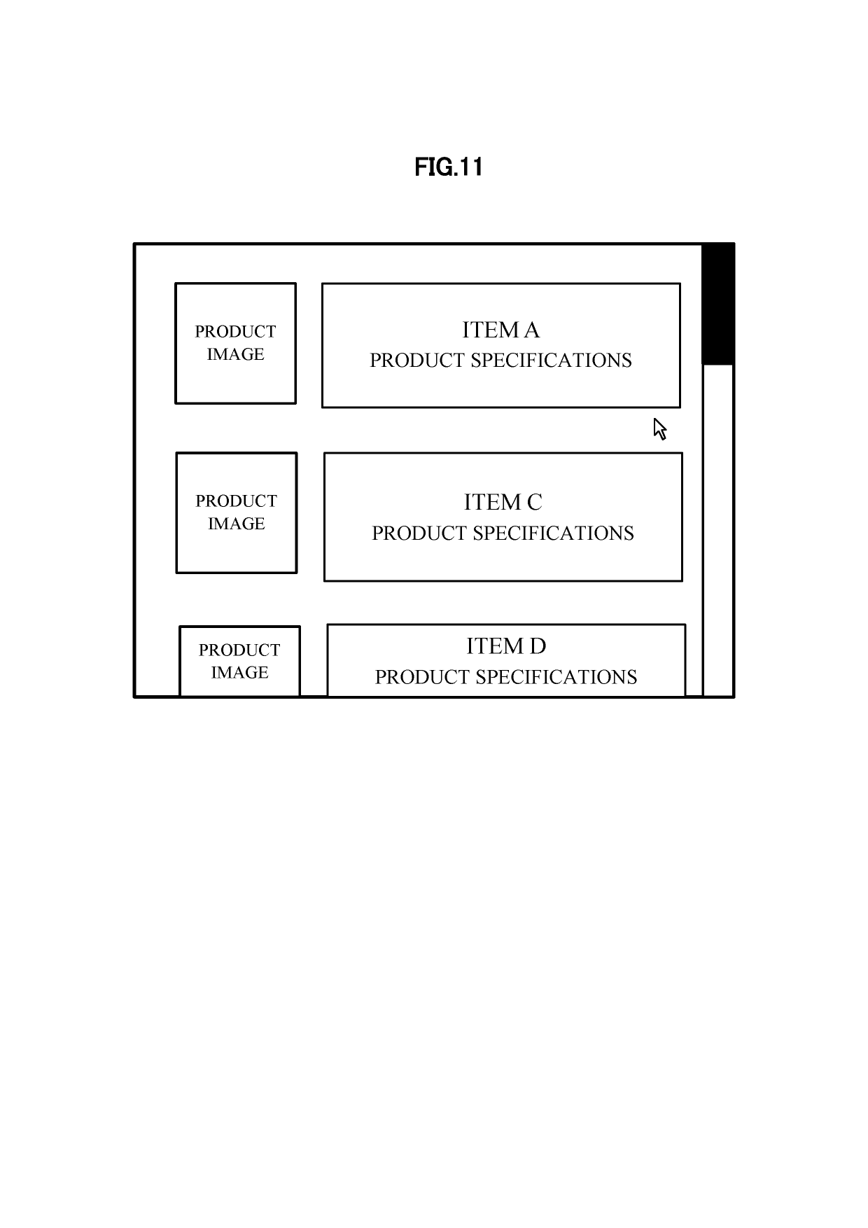

After Step S20, the control unit 120 provides the information terminal 200 with the item list of representative items belonging to the respective groups of the items classified in Step S20, using the function of the item presenter 128 (Step S21), and then terminates the searching process. Specifically, the item presenter 128 in Step S21 extracts (selects), as the representative item, the largest selling item from among the items belonging to each group formed in Step S20, on the basis of the information, such as the number of sales, received from the sales server 300, and then transmits the list (result list) of the extracted items to the information terminal 200, thereby presenting the item list to the user. For example, the item presenter 128 in Step S21 transmits the item list illustrated in FIG. 11 to the information terminal 200. As illustrated in FIG. 11, the item list contains data sets for the respective items, each containing a product image and detailed specifications of the item, and allows the user to purchase any of the products by performing manipulations. Specifically, the product specifications for each item contained in the item list also include a purchasing button, which is not illustrated, as well as the price and the desired number of purchases. That is, the item list also serves as a collection of sales websites. In the illustrated example, the group including “Item A” and “Item B” features the representative “Item A”, the group including “Item C” features the representative “Item C”, and the group including “Item D” features the representative “Item D”.

The information terminal 200, after receiving the item list provided in Step S21 illustrated in FIG. 4, displays the screen illustrated in FIG. 11. The information terminal 200 executes a purchasing step illustrated in FIG. 4 in response to user’s purchasing manipulations (Step S22), and then terminates the search requesting process. Specifically, the information terminal 200 in Step S22 transmits a purchase request to the sales server 300 in accordance with the user’s purchasing manipulations, and makes payment of the item related to the purchase request, by communicating with the sales server 300. These steps enable the user to purchase the desired part (item).

The search device 100 and each of the information terminals 200 execute the above-described operations. As described above, the search device 100 according to the embodiment prompts the user to designate the installation portion of the user’s desired part in the three-dimensional image, and can thus present, to the user, the name of the installation portion of the user’s desired part and the items applicable to the installation portion. The search device 100 can also enable the user to readily find the product even if the user does not know the commercial name of the desired product. The search device 100 can therefore allow the user to readily search for desired products.

### Modifications

The above-described embodiment of the present disclosure is a mere example and may be modified and developed in various manners. For example, the search device 100 and each of the information terminals 200 according to the above-described embodiment do not necessarily have all the technical features described above, and may have some of the components in the above-described embodiment to solve at least one problem in existing techniques. The embodiment may be modified based on any combination of at least some of the modifications described below.

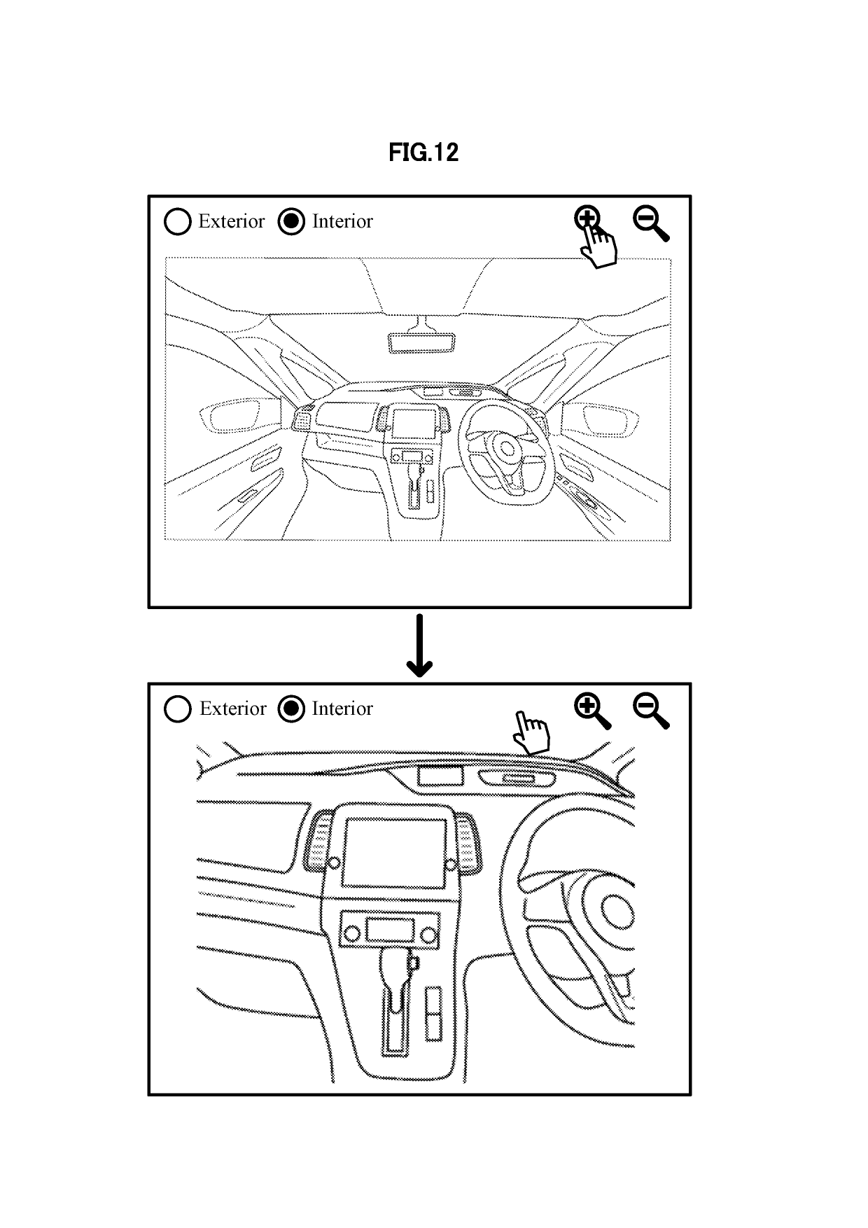

In the above-described embodiment, Step S13 illustrated in FIG. 4 involves providing three-dimensional exterior and interior images associated with the car model indicated by the car model information transmitted from the information terminal 200. Each of the three-dimensional images provided in Step S13 can be enlarged or contracted in the screen in accordance with a user’s manipulation. For example, when the user selects a plus button in a three-dimensional interior image provided in Step S13 as illustrated in the upper part of FIG. 12, the image is enlarged as illustrated in the lower part of FIG. 12. For another example, when the user selects a minus button in the image as illustrated in the lower part of FIG. 12, the image is contracted as illustrated in the upper part of FIG. 12. This feature enables the user to readily recognize the installation portion of the desired part.

Although the user is going to purchase a car part in the above-described embodiment, this assumption is a mere example. The search device 100 is applicable to not only a search for car parts but also a search for items in home carpentry, such as do-it-yourself (DIY) carpentry. For example, to the user going to additionally install any new item in a room, the search device 100 provides three-dimensional images of the room, and prompts the user to select the installation portion, thereby allowing the user to readily find the desired item.

Although Step S16 of emphasizing the area illustrated in FIG. 4 is followed by Step S17 of providing the area information in the above-described embodiment, this process is a mere example. The order of execution of Steps S16 and S17 may be inverted. Alternatively, Step S17 may also involve emphasizing the area in addition to providing the area information.

Although Step S20 illustrated in FIG. 4 involves classifying the items identified in Step S19 into groups in accordance with the degrees of similarity between product images of the items in the above-described embodiment, this process is a mere example. The process may skip Step S20 of classifying the items.

Step S21 illustrated in FIG. 4 involves extracting the largest selling items as the representative items and transmitting the list of the extracted items to the information terminal 200 in the above-described embodiment. This list may be configured to develop a sub-list containing the items belonging to one of the groups when the user selects the representative item of the group, for example. That is, the user may be allowed to view all the items in the group by selecting its representative item.

Although the searching process executed by the search device 100 in the embodiment is described using the exemplary three-dimensional interior images illustrated in FIGS. 7 to 10, this description is also applicable to three-dimensional exterior images. That is, the user going to purchase a part to be installed in the exterior of the car selects the intended portion to be provided with the part, as in the case of the interior part.

Although Step S18 illustrated in FIG. 4 that involves selecting the name of the installation portion of the user’s desired part as the purchase related portion is followed by Step S19 and the subsequent steps in the above-described embodiment, this process is a mere example. Alternatively, Step S17 may involve, in addition to providing the area information, identifying the items associated with the area information (indicating the name of the installation portion) and providing the item list, for example. That is, Step S17 may involve Step S19 and the subsequent steps without Step S18, in other words, involve providing the area information (indicating the name of the installation portion) with the item list. In this modification, the item list may be provided in the form of a page independent from the area information. Alternatively, each of the names of the installation portions indicated by the area information may accompany the corresponding item. In such a modification of providing the items associated with the area information as search results without Step S18, the items are displayed in accordance with the proprieties depending on the inclusion relation between the installation portions. In an exemplary case of a smaller installation portion A included in a larger installation portion B, the items applicable to the installation portion A are displayed in priority to the items applicable to the installation portion B.

The functions of the search device 100 and the information terminal 200 according to the above-described embodiment may be performed by not only a dedicated device but also an ordinary computer. For example, a program designed to cause a computer to execute any of the functions may be installed from a non-transitory recording medium into a computer, so that the computer may serve as a search device 100 for executing the above-described process. Alternatively, multiple computers may cooperate with each other and thus serve as a single search device 100 or information terminal 200.

In the case where the above-described functions are achieved by sharing of an operating system (OS) and an application or by cooperation of the OS and the application, only the components other than the OS may be stored in a non-transitory recording medium, for example.

The program may be distributed via a communication network while being superimposed on a carrier wave. For example, the program may be posted on a bulletin board system (BBS) on a communication network and may be distributed via the network. A computer may activate this program and execute the program under the control of the OS in the same manner as the other application programs, and thereby execute the above processes.

The following is a list of some modes of the present disclosure in the form of appendixes.

### Appendix 1

A search device, including:

a three-dimensional image provider to provide a three-dimensional image;

an intended portion identifier to identify, based on a position selected by a user in a target represented by the three-dimensional image, an intended portion intended by the user;

an area information provider to provide pieces of area information indicating names of areas encompassing the intended portion identified by the intended portion identifier;

an applicable item identifier to identify items associated with a piece of area information selected by the user from among the pieces of area information provided by the area information provider; and

an item presenter to provide an item list through which the user can purchase any of the items identified by the applicable item identifier.

### Appendix 2

The search device according to Appendix 1, further comprising:

an area emphasizer to emphasize the intended portion identified by the intended portion identifier in the three-dimensional image, so as to enable the user to recognize the intended portion, the intended portion being included in the target represented by the three-dimensional image.

### Appendix 3

The search device according to Appendix 2, wherein

the intended portion identifier temporarily identifies, in response to a user’s selection of a first position in the target represented by the three-dimensional image, the intended portion based on the first position, and then reidentifies, in response to a user’s selection of a second position in the target represented by the three-dimensional image, the intended portion based on the second position, and

the area emphasizer provides a first emphasis screen for emphasizing the intended portion based on the first position, and then causes the first emphasis screen to transition to a second emphasis screen for emphasizing the intended portion based on the second position.

### Appendix 4

The search device according to any one of Appendixes 1 to 3, further comprising:

an item classifier to classify the items identified by the applicable item identifier into groups in accordance with degrees of similarity between the items, wherein

the item presenter provides representative items in a form of the item list, each of the representative items being selected from one of the groups of the items classified by the item classifier.

### Appendix 5

A search device, comprising:

an item identifier to identify items desired by a user;

an item classifier to classify the items identified by the item identifier into groups in accordance with degrees of similarity between the items;

a representative item selector to select representative items of the respective groups of the items classified by the item classifier; and

a result list provider to provide a result list including the representative items of the respective groups classified by the item classifier.

### Appendix 6

A searching method executable by a search device, the searching method involving:

a three-dimensional image providing step of providing a three-dimensional image;

an intended portion identifying step of identifying, based on a position selected by a user in a target represented by the three-dimensional image, an intended portion intended by the user;

an area information providing step of providing pieces of area information indicating names of areas encompassing the intended portion identified in the intended portion identifying step;

an applicable item identifying step of identifying items associated with a piece of area information selected by the user from among the pieces of area information provided in the area information providing step; and

an item providing step of providing an item list through which the user can purchase any of the items identified in the applicable item identifying step.

### Appendix 7

A non-transitory computer-readable recording medium that stores a program, the program causing a computer to function as:

a three-dimensional image provider to provide a three-dimensional image;

an intended portion identifier to identify, based on a position selected by a user in a target represented by the three-dimensional image, an intended portion intended by the user;

an area information provider to provide pieces of area information indicating names of areas encompassing the intended portion identified by the intended portion identifier;

an applicable item identifier to identify items associated with a piece of area information selected by the user from among the pieces of area information provided by the area information provider; and

an item presenter to provide an item list through which the user can purchase any of the items identified by the applicable item identifier.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can provide a search device, a searching method, and a recording medium that allow a user to readily search for desired products.

1. A search device, comprising:
at least one processor, wherein
the processor
provides a three-dimensional image,
identifies, based on a position selected by a user in a target represented by the three-dimensional image, an intended portion intended by the user,
provides pieces of area information indicating names of areas encompassing the identified intended portion,
identifies items associated with a piece of area information selected by the user from among the provided pieces of area information, and
provides an item list through which the user can purchase any of the identified items.

2. The search device according to claim 1, wherein the processor emphasizes the identified intended portion in the three-dimensional image, so as to enable the user to recognize the intended portion, the intended portion being included in the target represented by the three-dimensional image.

3. The search device according to claim 2, wherein
the processor
temporarily identifies, in response to a user’s selection of a first position in the target represented by the three-dimensional image, the intended portion based on the first position, and then reidentifies, in response to a user’s selection of a second position in the target represented by the three-dimensional image, the intended portion based on the second position, and
provides a first emphasis screen for emphasizing the intended portion based on the first position, and then causes the first emphasis screen to transition to a second emphasis screen for emphasizing the intended portion based on the second position.

4. The search device according to claim 1, wherein the processor
classifies the identified items into groups in accordance with degrees of similarity between the items, and
provides representative items in a form of the item list, each of the representative items being selected from one of the groups of the classified items.

5. A search device, comprising:
at least one processor, wherein
the processor
identifies items desired by a user,
classifies the identified items into groups in accordance with degrees of similarity between the items,
selects representative items of the respective groups of the classified items, and
provides a result list including the representative items of the respective groups.

6. A searching method executable by a search device, the searching method comprising:
providing a three-dimensional image;
identifying, based on a position selected by a user in a target represented by the three-dimensional image, an intended portion intended by the user;
providing pieces of area information indicating names of areas encompassing the identified intended portion;
identifying items associated with a piece of area information selected by the user from among the provided pieces of area information; and
providing an item list through which the user can purchase any of the identified items.

7. A non-transitory computer-readable recording medium that stores a program, the program causing a computer to:
provide a three-dimensional image;
identify, based on a position selected by a user in a target represented by the three-dimensional image, an intended portion intended by the user;
provide pieces of area information indicating names of areas encompassing the identified intended portion;
identify items associated with a piece of area information selected by the user from among the provided pieces of area information; and
provide an item list through which the user can purchase any of the identified items.
